(19) United States
(12) Patent Application Publication
(10) Pub. No.: US 2019/0121590 A1
(43) Pub. Date: Apr. 25, 2019

(54) SYSTEM AND METHOD FOR PROVIDING MOBILE PRINTING

(71) Applicant: HP Printing Korea Co., Ltd., Suwon-si (KR)

(72) Inventors: Jeong-hun KIM, Suwon-si (KR); In-chang PARK, Suwon-si (KR)

(21) Appl. No.: 16/230,864

(22) Filed: Dec. 21, 2018

Related U.S. Application Data
(63) Continuation of application No. PCT/KR2016/009143, filed on Aug. 19, 2016.

(30) Foreign Application Priority Data
Jun. 27, 2016 (KR) 10-2016-0080243

(51) Int. Cl. G06F 3/12

(52) U.S. Cl. CPC G06F 3/1292; G06F 3/1297; G06F 3/1226; G06F 3/1205

(57) ABSTRACT

A method of providing mobile printing is provided. The method includes transmitting a device search message based on a predetermined protocol in a mobile terminal, transmitting, when a user device receives the device search message from the mobile terminal, a response message based on the predetermined protocol to the mobile terminal in response to the received device search message, transmitting, when information indicating a mobile printing function is included in a device category of the response message received from the user device, print data from the mobile terminal to the user device, transmitting the print data received from the user device to an image forming apparatus, and performing an image forming job for the received print data in the image forming apparatus.

### BACKGROUND

Examples of an image forming apparatus include an individual device such as a printer, a scanner, a copier, a facsimile machine, and a multi-function product (MFP) in which various functions of different devices are integrated into one device. Recently, such an image forming apparatus may be equipped with a wired communication module such as an Ethernet module or a wireless communication module such as a Wi-Fi, Wi-Fi Direct, near field communication (NFC), Bluetooth, Zigbee, or Infrared Data Association (IrDA) module, and thus the image forming apparatus may be connected to another user device such as a mobile device or a notebook through a network. In addition, the image forming apparatus may access a cloud server by using the above-described modules to thereby use tasks and applications provided by the cloud server.

As devices such as user terminals become common, methods of managing and transmitting print data in a portable device as well as a personal computer (PC) are desired.

### BRIEF DESCRIPTION OF DRAWINGS

The above and other aspects, features, and advantages of certain examples of the disclosure will be more apparent from the following description taken in conjunction with the accompanying drawings, in which:

FIG. 1 is a diagram illustrating a configuration of an image forming apparatus, according to an example.

FIG. 2 is a diagram illustrating a system for providing mobile printing, according to an example.

FIG. 3 is a diagram illustrating a hardware configuration of a user device, such as the user device of FIG. 2, according to an example.

FIG. 4 is a diagram illustrating a process of searching for a device in a system that provides mobile printing, according to an example.

FIG. 5 is a diagram illustrating a method of providing mobile printing, according to an example.

FIGS. 6 and 7 are diagrams illustrating a process of retrieving information about an image forming apparatus usable in a system for providing mobile printing, according to an example.

FIG. 8 is a diagram illustrating a process of performing an image forming job in a system that provides mobile printing, according to an example.

FIG. 9 is a diagram illustrating a process of a method of providing mobile printing in a system that provides mobile printing, according to an example.

FIG. 10 is a flowchart illustrating a method of providing mobile printing, according to an example.

Throughout the drawings, it should be noted that like reference numbers are used to depict the same or similar elements, features, parts, components, and structures.

### DETAILED DESCRIPTION OF EXAMPLES

Hereinafter, various examples will be described with reference to the drawings. The examples described below may be modified and implemented in various different forms. In order to more clearly describe the features of the examples, detailed descriptions of known matters to those of ordinary skill in the art will be omitted.

In the specification, when an element is referred to as being “connected” with another element, it includes not only a case of being directly connected, but also a case of being connected with another element in between. Also, when an element is referred to as “including” another element, it is to be understood that the element may include other elements unless specifically stated otherwise.

In the specification, an “image forming job” may mean various jobs related to images (e.g., printing, copying, scanning or faxing), such as forming an image or creating/storing/transmitting of an image file, and “job” may mean not only an image forming job but also a series of processes necessary for or related to performing an image forming job.

Also, an “image forming apparatus” may mean any apparatus capable of performing an image forming job, such as a printer, a copier, a scanner, a fax machine, a multi-function printer (MFP), a display, or the like.

Also, “print data” may mean data converted into a printable format in a printer.

Also, a “scanned file” may mean a file generated by scanning an image by a scanner.

Also, a “user” may mean a person who performs an operation related to an image forming job using an image forming apparatus or a device connected with an image forming apparatus in a wired or wireless manner. Also, “administrator” may mean a person who has authority to access all the functions and systems of the image forming apparatus. The “administrator” and the “user” may be the same person.

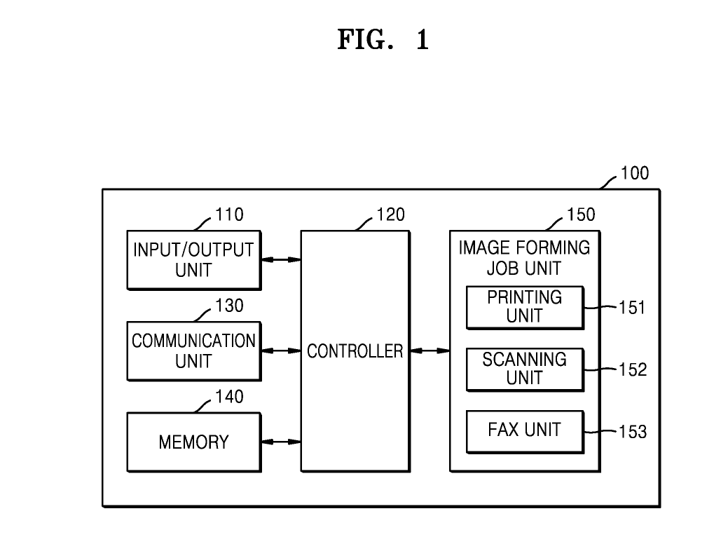

FIG. 1 is a diagram illustrating a configuration of an image forming apparatus according to an example.

Referring to FIG. 1, an image forming apparatus 100, according to an example, may include an input/output unit 110, a controller 120, a communication unit 130, a memory 140, and an image forming job unit 150. Further, although not shown, the image forming apparatus 100 may further include a power supply for supplying power to respective components.

The input/output unit 110 may include an input unit for receiving an input, etc. for performing an image forming job from a user, and an output unit for displaying information on the result of the image forming job, the status of the image forming apparatus 100, etc. For example, the input/output unit 110 may include an operation panel for receiving a user input and a display panel for displaying a screen.

As an example, the input unit may include a device capable of receiving various types of user input, such as, for example, a keyboard, a physical button, a touch screen, a camera, a microphone, or the like. Further, the output unit may include, for example, a display panel, a speaker, or the like. However, the present disclosure is not limited to these examples, and the input/output unit 110 may include various other input/output devices.

The controller 120 may control an operation of the image forming apparatus 100 and may include a processor such as a CPU or the like. The controller 120 may control other components included in the image forming apparatus 100 to perform an operation corresponding to the user input received through the input/output unit 110.

For example, the controller 120 may execute a program stored in the memory 140, read a file stored in the memory 140, or store a new file in the memory 140.

The communication unit 130 may perform wired/wireless communication with another device or a network. To this end, the communication unit 130 may include a communication module, such as a transceiver, supporting at least one of various wired/wireless communication methods. For example, the communication module may be in the form of a chipset, or may be a sticker/barcode (e.g., a sticker containing an NFC tag) or the like that contains information necessary for communication.

The wireless communication may include at least one of, for example, Wireless Fidelity (Wi-Fi), Wi-Fi Direct, Bluetooth, Ultra Wide Band (UWB), Near Field Communication (NFC), or the like. The wired communication may include at least one of, for example, universal serial bus (USB), High Definition Multimedia Interface (HDMI), or the like.

The communication unit 130 may be connected to an external device located outside the image forming apparatus 100 and transmit/receive signals or data. For example, the image forming apparatus 100 may be connected to a user device through the communication unit 130. The communication unit 130 may transmit signals or data received from the user device to the controller 120 or may transmit signals or data generated by the controller 120 to the user device. For example, when the communication unit 130 receives a print command signal and print data from the user device, the controller 120 may output the received print data through a printing unit 151.

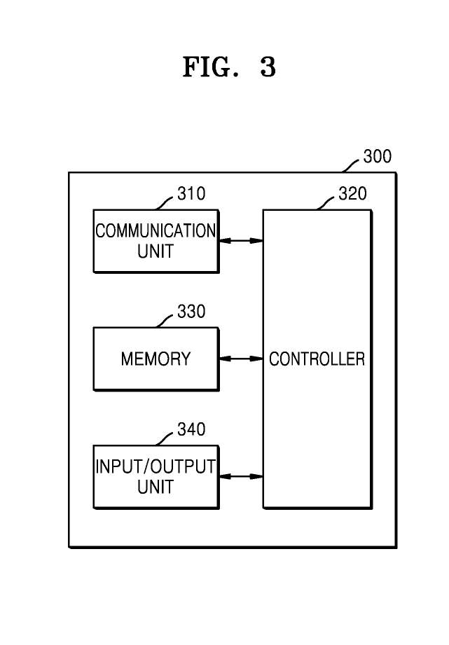

The user device may include, for example, a PC, a smart phone, a tablet, a home appliance, a medical device, a camera, and a wearable device. An example of a hardware configuration of a user device will be described later with reference to FIG. 3.

As illustrated in FIG. 1, various kinds of data, such as files, and programs, such as an application, may be installed and stored in the memory 140. The controller 120 may access the data stored in the memory 140 and use the data or may store new data in the memory 140. Further, the controller 120 may execute a program installed in the memory 140. In addition, the controller 120 may install an application received from an external side through the communication unit 130 in the memory 140.

The image forming job unit 150 may perform an image forming job such as printing, copying, scanning, or faxing.

The image forming job unit 150 is shown as including the printing unit 151, a scanning unit 152, and a fax unit 153. In other examples, the image forming job unit 150 may include only some of these components or may further include a component for performing another kind of image forming job.

The printing unit 151 may form an image on a recording medium by various printing methods such as an electrophotographic method, an inkjet method, a thermal transfer method, a direct thermal method, or the like.

The scanning unit 152 may irradiate a document with light, receive the reflected light, and read an image recorded in the document. For example, a charge coupled device (CCD) or a contact type image sensor (CIS) may be employed as an image sensor for reading the image from the document. The scanning unit 152 may have a flatbed structure in which a document is positioned at a fixed position and an image is read while an image sensor is moved, a document feed structure in which the image sensor is positioned at a fixed position and the document is transported, or a composite structure thereof.

The fax unit 153 may share the configuration for scanning an image with the scanning unit 152, share the configuration for printing a received file with the printing unit 151, and transmit a scanned file to a destination or receive a file from an external side.

The input/output unit 110 of FIG. 1 may have a unique control system. Namely, the input/output unit 110 may have a control system (e.g., a controller, a memory, etc.) for controlling a user interface (UI) provided by the input/output unit 110 separately from the controller 120 of the image forming apparatus 100. Further, programs such as an operating system (OS) for providing a UI and an application for supporting various functions may be installed in the control system of the input/output unit 110.

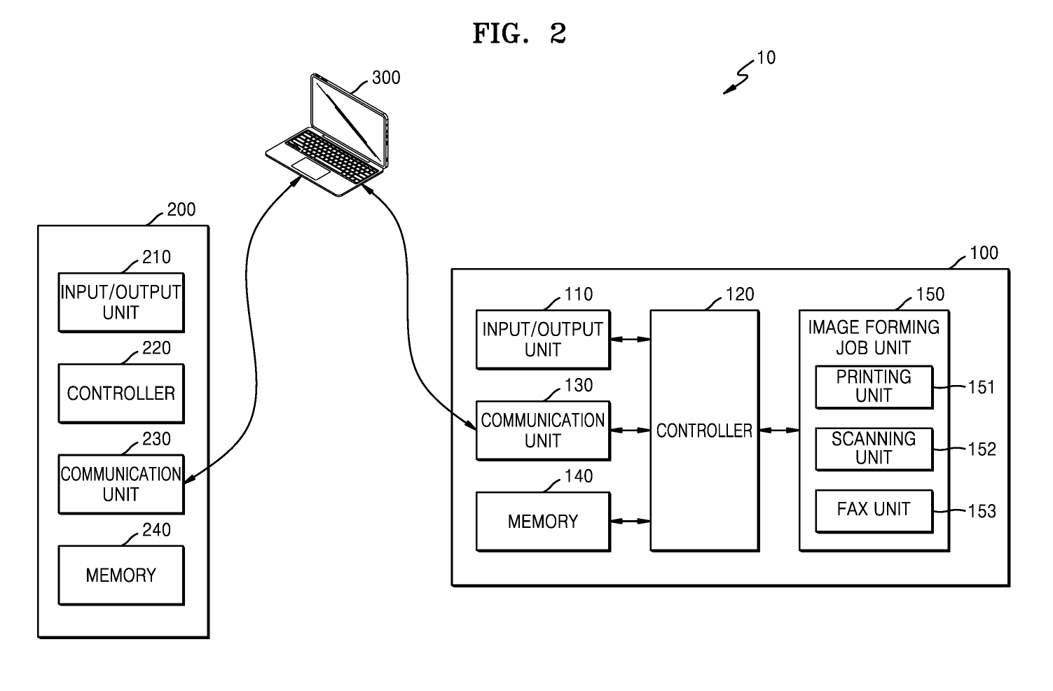

FIG. 2 is a diagram illustrating a system for providing mobile printing, according to an example.

Referring to FIG. 2, a system 10 for providing mobile printing, according to an example, may include an image forming apparatus 100, a mobile terminal 200, and a user device 300.

The mobile terminal 200, according to an example, may be a mobile user device providing a mobile printing function and may include an input/output unit 210, a controller 220, a communication unit 230, and a memory 240.

The mobile terminal 200 may support various functions such as receiving print data from the mobile terminal 200 for mobile printing and searching for an image forming apparatus to perform an image forming job.

In more detail, the mobile terminal 200 may search for an image forming apparatus capable of performing an image forming job using a predetermined protocol. As an example, a Windows 10 Mobile operating system may have been installed in the controller 220 of the mobile terminal 200, and the mobile terminal 200 may search for the image forming apparatus using a web services dynamic discovery (WS Discovery) protocol.

The WS Discovery protocol is a network communication protocol and is a multicast discovery protocol running on Windows operating systems. The WS Discovery protocol may be used to retrieve devices on the network by multicasting a user datagram protocol (UDP) message (packet). The UDP message may consist of an Ether header, an IP header, a UDP header, and application data in order. The WS Discovery protocol may use a UDP port 3702 and may use an IP multicast address 239.255.255.250.

The mobile terminal 200, according to an example, supports the mobile printing function directly in the operating system by searching for the device using the WS Discovery protocol provided in the Windows 10 Mobile operating system. That is, the mobile terminal 200, according to an example, may render the print data in a format that may be directly printed through the operating system, thereby supporting the mobile printing function on the print data in all formats.

However, when the image forming apparatus 100 does not support the WS Discovery protocol, the mobile terminal 200 cannot search for the image forming apparatus 100, and thus cannot perform the image forming job using the image forming apparatus 100. For example, the image forming apparatus 100 may be an image forming apparatus that supports only a Simple Network Management Protocol (SNMP) protocol or a USB printer that does not support a network communication protocol.

The system 10, according to an example, may use the user device 300 as a virtual printer to support mobile printing using the mobile terminal 200 for the image forming apparatus 100 that does not support the WS Discovery protocol.

For example, the user device 300 may be a device supporting the WS Discovery protocol and may include, for example, a PC, a smart phone, a tablet, a home appliance, a medical device, a camera, a wearable device, or the like.

In the system 10, according to an example, the mobile terminal 200 may transmit a device search message based on a predetermined protocol through the communication unit 230. For example, the predetermined protocol may be a WS Discovery protocol, and the mobile terminal 200 may transmit the device search message to the user device 300 supporting the WS Discovery protocol.

When receiving the device search message based on a predetermined protocol, the user device 300 may transmit a response message, based on the predetermined protocol, to the mobile terminal 200. The user device 300 may include information indicating the mobile printing function in a device category of the response message and transmit the information. The device category of the response message is a field indicating a function or a role that may be performed by the user device 300 transmitting the response message or a service that may be provided by the user device 300. For example, the device category of the response message transmitted by the user device 300 may include a function or a role such as “mobile printer.”

The mobile terminal 200 may determine whether to transmit the print data to the user device 300 using the received response message. For example, the communication unit 230 of the mobile terminal 200 may receive a response message based on the WS Discovery protocol, and the controller 220 may analyze the device category of the response message to thereby understand functions which may be performed by the user device 300.

If information indicating the mobile printing function is included in the device category of the response message, the controller 220 of the mobile terminal 200 may recognize the user device 300 as a virtual printer to thereby transmit print data for the image forming job to the user device 300 through the communication unit 230. At this time, the print data to be transmitted to the user device 300 may be rendered in a printable format through the operating system of the mobile terminal 200. The printable format is a data format which may be processed by an image forming apparatus such as the image forming apparatus 100 and may include, for example, a PWG Raster, an OpenXPS, an MS XPS, a PCLm, or the like.

The user device 300, according to an example, may receive print data and a print request from the mobile terminal 200 and transmit the print data and the print request to the image forming apparatus 100. The user device 300 may determine the image forming apparatus 100 to perform the image forming job on the print data using the identification information of the mobile terminal 200 that has transmitted the print data. The identification information of the mobile terminal 200 is information uniquely held by the mobile terminal 200 and may include an IP address, a mobile phone number, etc.

For example, the user device 300, according to an example, may find information on the image forming apparatus corresponding to the IP address by using the IP address of the mobile terminal 200.

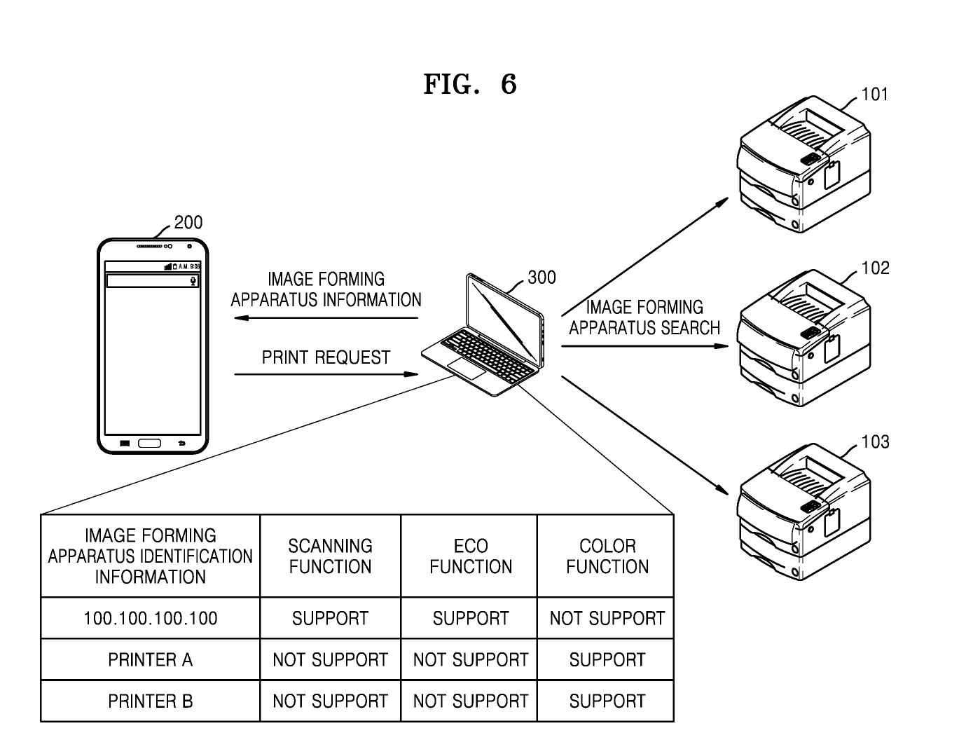

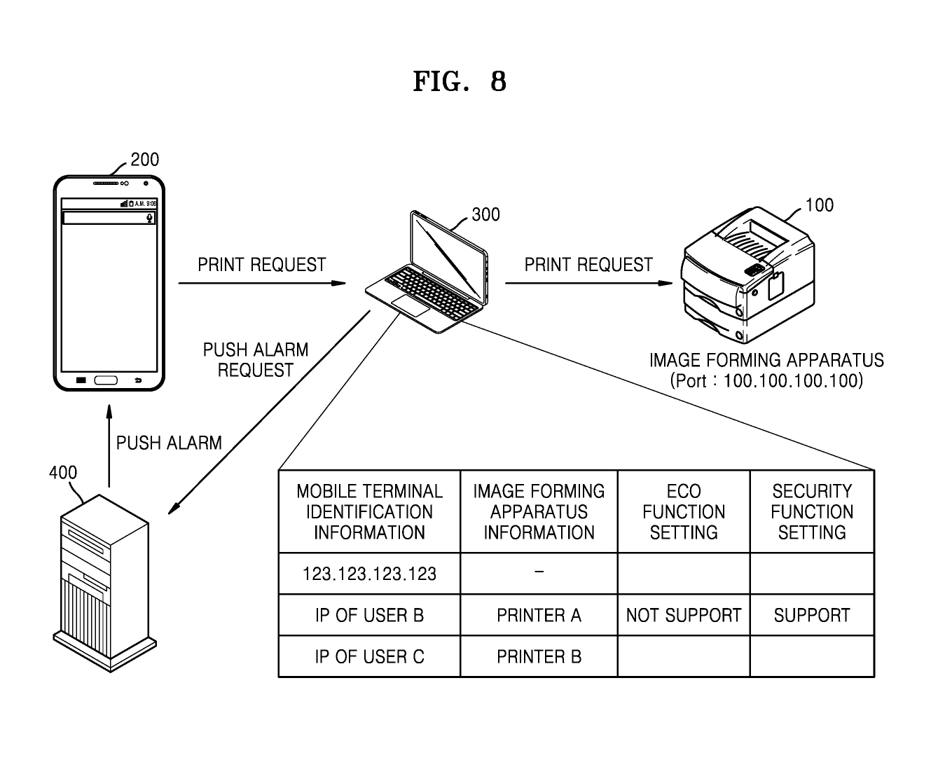

Information on the image forming apparatus corresponding to the identification information of the mobile terminal 200 may have been previously set and stored in the user device 300. An example of a method of setting the information will be described later with reference to FIGS. 6 and 8.

The information on the image forming apparatus corresponding to the identification information of the mobile terminal 200 may include the identification information of the image forming apparatus which is set to be used by the user of the mobile terminal 200, setting information which is necessary for the execution of the image forming job, or the like. The setting information necessary for performing the image forming job may include information on a printing paper at the time of performing a printing job, information on the number of sheets to be printed, information on a printing method, information on a color setting, information on an ECO function setting, information on a security function setting, or the like.

The user device 300, according to an example, may transmit print data and setting information to the image forming apparatus 100 indicated by the identification information of the image forming apparatus, and the image forming apparatus 100 may perform the image forming job for the print data.

According to an example, when there is a request of an image forming job from a user in the mobile terminal 200, the image forming apparatus 100, which does not support the WS Discovery protocol, may also perform the image forming job by using the user device 300, which supports the WS Discovery protocol.

FIG. 3 is a diagram illustrating a hardware configuration of a user device, such as the user device of FIG. 2, according to an example.

Referring to FIG. 3, the user device 300, according to an example, includes a communication unit 310, a controller 320, a memory 330, and an input/output unit 340.

The communication unit 310 may be connected to an external device, located outside the user device 300, to transmit and receive signals or data. The communication unit 310 may include a communication module, such as a transceiver, supporting at least one of various wired/wireless communication methods. For example, the communication module may be in the form of a chipset, or may be a sticker/barcode (e.g., a sticker containing an NFC tag) or the like that contains information necessary for communication.

As an example, the communication unit 310 may receive a device search message based on a predetermined protocol from the mobile terminal 200 by using the predetermined protocol. The predetermined protocol, according to an example, may be the WS Discovery protocol.

Also, the communication unit 310 may transmit a response message, based on the predetermined protocol, to the mobile terminal 200 in response to the device search message. The response message may include information indicating a mobile printing function in the device category and may be transmitted through the communication unit 310 under the control of the controller 320.

The controller 320 may control an operation of the user device 300 and may include a processor such as a CPU. The controller 320 may control other components of the user device 300 to perform operations corresponding to the signals or data received through the communication unit 310 or the user input received through the input/output unit 340.

For example, the controller 320, according to an example, may generate a response message including information indicating the mobile printing function in the device category of the response message, and may transmit the generated response message to the mobile terminal 200 through the communication unit 310.

The controller 320 may obtain the identification information of the mobile terminal 200 that has transmitted the print data and obtain information on the image forming apparatus corresponding to the identification information of the mobile terminal 200 by referring to the memory 330. The controller 320 may determine the image forming apparatus 100 which is to perform the image forming job for the print data and setting information necessary for the image forming job, based on information on the image forming apparatus.

If the memory 330 does not have information on the image forming apparatus corresponding to the identification information of the mobile terminal 200, the controller 320 may request the information on the image forming apparatus from the mobile terminal 200 through the communication unit 310. For example, the controller 320 may provide the mobile terminal 200 with the list of image forming apparatuses stored in the memory 330 through the communication unit 310 and may receive information on one image forming apparatus selected by the user from the mobile terminal 200. For example, the identification information of the selected image forming apparatus and the setting information necessary for the image forming job may be received.

The controller 320 may transmit the print data and the setting information necessary for the image forming job to the determined image forming apparatus 100 through the communication unit 310. In addition, the controller 320 may determine whether the print data received from the mobile terminal 200 is of a format printable in the determined image forming apparatus 100. Since the mobile terminal 200 renders the print data in a printable format and transmits the rendered print data, but the printable format may be different per the image forming apparatus such that not that all printable formats are supported, the print data received from the mobile terminal 200 may be determined as a format that is not printable in the image forming apparatus 100.

If it is determined that the received print data is of a format that is not printable in the image forming apparatus 100, the controller 320 may convert the print data into a format that is printable in the image forming apparatus 100 and transmit the converted print data. At this time, the information of the format printable in the image forming apparatus 100 may be received from the image forming apparatus 100 through the communication unit 310, or may already have been included in the information on the image forming apparatus and stored in the memory 330.

Programs such as an application and various kinds of data such as a file may be installed and stored in the memory 330. The controller 320 may access the data stored in the memory 330 and use the data or store new data in the memory 330. In addition, the controller 320 may execute a program installed in the memory 330. In addition, the controller 320 may install an application received from an external side through the communication unit 310 in the memory 330.

The memory 330 may include information about image forming apparatuses available through the user device 300. For example, the memory 330 may store a list of image forming apparatuses connected to the user device 300 in a wired or wireless manner. The list of image forming apparatuses may include identification information of the image forming apparatuses and information on functions supported by the image forming apparatuses.

In addition, the memory 330 may store information on the image forming apparatus corresponding to the identification information of the mobile terminal 200. For example, the information on the image forming apparatus corresponding to the identification information of the mobile terminal 200 may include the identification information of the image forming apparatus which has been set to be used by the user of the mobile terminal 200, and setting information necessary for the image forming job of the mobile terminal 200, etc.

The input/output unit 340 may include an input unit for receiving an input, etc. from the user, and an output unit for displaying information to the user. For example, the input/output unit 340 may include an operation panel for receiving a user input and a display panel for displaying a screen.

Input devices capable of receiving various forms of user inputs, such as a keyboard, a physical button, a touch screen, a camera, a microphone, etc., and output devices such as a monitor, a display panel, a speaker, etc., may be included in the input/output unit 340. However, the present disclosure is not limited to these examples, and the input/output unit 340 may include various other input/output devices.

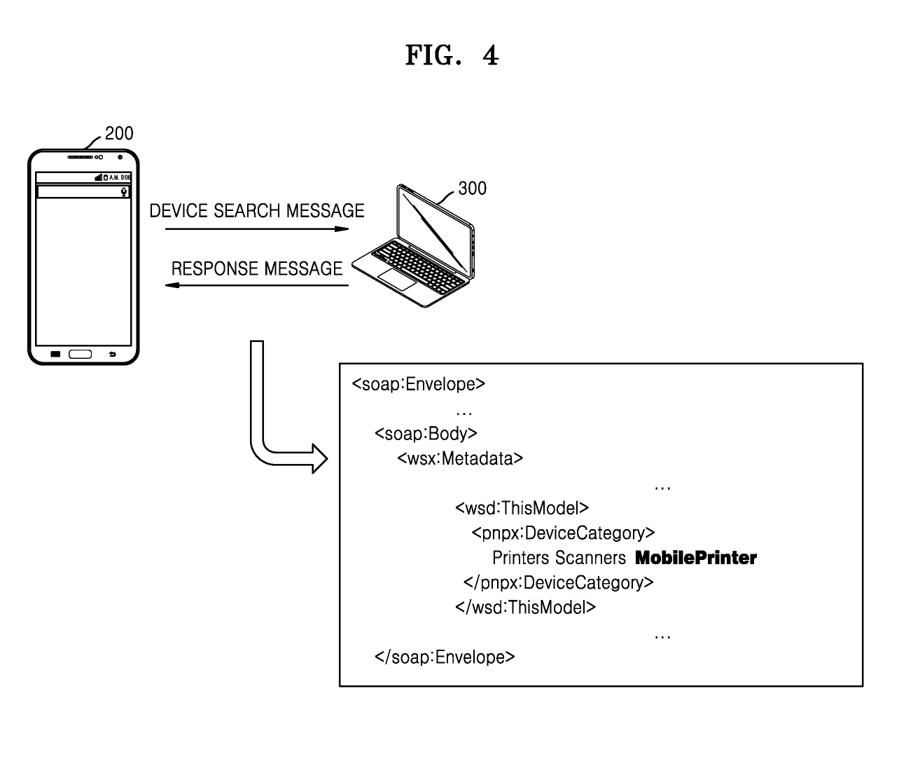

FIG. 4 is a diagram illustrating a process of searching for a device in a system that provides mobile printing, according to an example.

Referring to FIG. 4, the mobile terminal 200, according to an example, may transmit a device search message based on the WS Discovery protocol to the user device 300. The device discovery message based on the WS Discovery protocol may be a probe message used when searching for a target service corresponding to a type or a scope.

When receiving the device search message from the mobile terminal 200, the user device 300 may transmit a response message based on the WS Discovery protocol to the mobile terminal 200. The response message based on the WS Discovery protocol may be a probe match message used as a response to the target service for the probe message.

The user device 300 may include information indicating the mobile printing function in the device category of the response message and transmit the information. The device category of the response message is a field indicating functions and roles that may be performed by the user device 300 transmitting the response message or services that may be provided by the user device 300. For example, referring to FIG. 4, the user device 300 may add a function or a role such as “Mobile Printer” to the device category of the response message to thereby be transmitted to the mobile terminal 200.

The mobile terminal 200 may analyze the device category of the response message received from the user device 300 to thereby determine whether to use the user device 300 as a virtual image forming apparatus for the mobile printing.

In FIG. 4, since the device category of the response message includes the “Mobile Printer,” the mobile terminal 200 may recognize the user device 300 as a virtual image forming apparatus supporting mobile printing. The mobile terminal 200 may perform the image forming job by using the image forming apparatuses stored in the user device 300 through the user device 300.

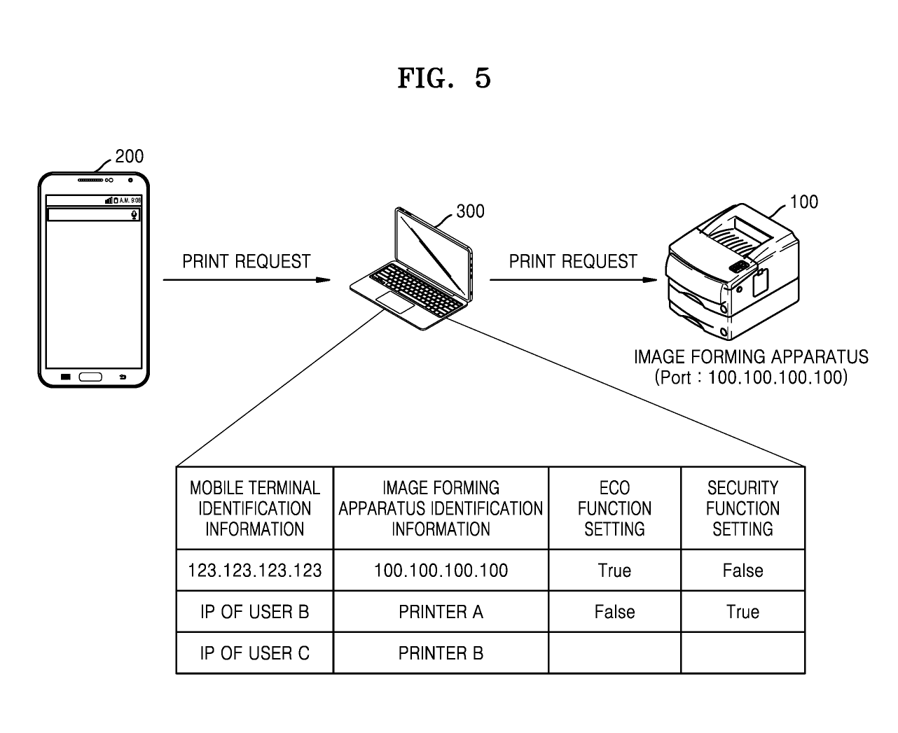

An example of a method by which the mobile terminal 200 may provide mobile printing using the user device 300 will be described later with reference to FIG. 5 to FIG. 8.

FIG. 5 is a diagram illustrating a method of providing mobile printing, according to an example.

Referring to FIG. 5, if receiving a request for an image forming job from a user, the mobile terminal 200, according to an example, may transmit the request to the user device 300 recognized as a virtual printer.

For example, when receiving a print request from a user, the mobile terminal 200 may transmit the print request to the user device 300 together with the print data. The print data transmitted by the mobile terminal 200 may be data having been rendered in a printable format through the operating system of the mobile terminal 200.

When receiving the print request, the user device 300 may determine an image forming apparatus to perform the image forming job on the print data by using the identification information of the mobile terminal 200.

As an example, the user device 300 may have information on a plurality of image forming apparatuses connected to the user device 300 in a wired or wireless manner. The information on the image forming apparatus may include identification information of the image forming apparatus and setting information necessary for performing the image forming job.

As illustrated in FIG. 5, the user device 300 may store information on a plurality of image forming apparatuses corresponding to identification information of a plurality of mobile terminals. For example, the user device 300 may store identification information and setting information of an image forming apparatus corresponding to the IP address 123.123.123.123 of the mobile terminal 200. The identification information of the image forming apparatus corresponding to the IP address of the mobile terminal 200 is the port number 100.100.100.100 and the setting information may include information indicating that the ECO function is used and the security function is not used.

The user device 300, according to an example, may determine the image forming apparatus to perform the printing job by using the identification information of the mobile terminal 200 as the image forming apparatus 100 of the port number 100.100.100.100, and may determine that the ECO function is used and the security function is not used at the time of performing the image forming job.

The ECO function is a function for saving consumables of the image forming apparatus. For example, the ECO function may include a function of printing color data as black and white data, a function of printing data of a plurality of color components as data of a predetermined number of color components less than the plurality of color components, a function of printing a plurality of pages on one page together, or the like.

The security function may be a function for performing user authentication in order to perform the image forming job in the image forming apparatus.

The user device 300 may transmit the print data together with the setting information to the determined image forming apparatus 100. At this time, the user device 300 may determine whether the rendered print data is of a printable format supported by the image forming apparatus 100. If the print data is of a format not supported by the image forming apparatus 100, the user device 300 may convert the print data into a printable format supported by the image forming apparatus 100. For example, when the image forming apparatus 100 supports only the PWG Raster format, the user device 300 may convert the print data of the OpenXPS format into data of the PWG Raster format and transmit the converted data to the image forming apparatus 100.

The image forming apparatus 100 may receive the print data and perform the image forming job.

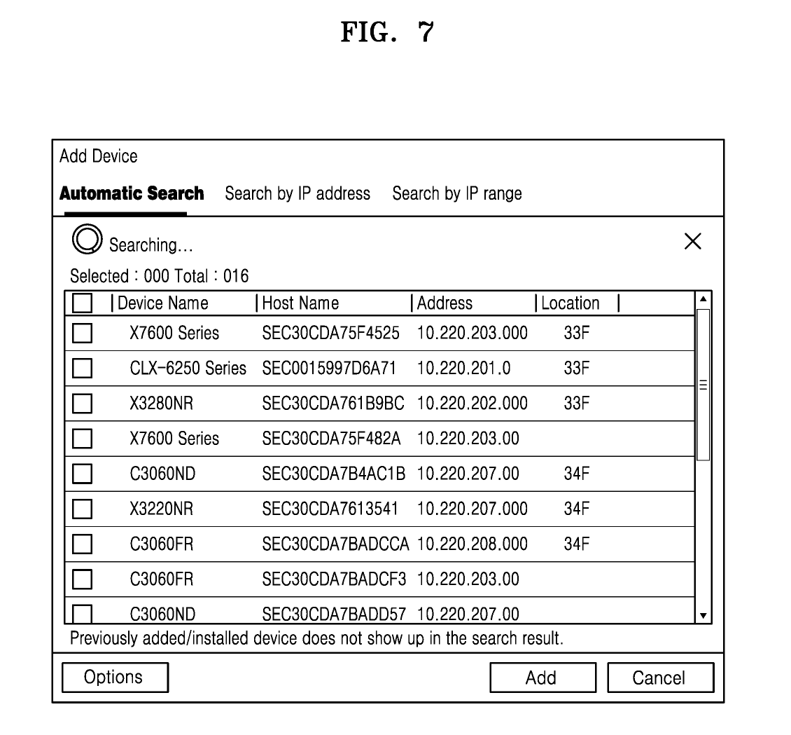

FIGS. 6 and 7 are diagrams illustrating a process of retrieving information about an image forming apparatus usable in a system for providing mobile printing, according to an example.

Referring to FIG. 6, the user device 300, according to an example, may provide the mobile terminal 200 with information about an image forming apparatus that may be used for the image forming job.

The user device 300 may search for a plurality of image forming apparatuses 101, 102, and 103 connected to the user device 300 in a wired or wireless manner. For example, the user device 300 may search for image forming apparatuses that have already been installed with a driver through a printer driver installed in the user device 300. In addition, the user device 300 may transmit a search message by using a network protocol, such as an SNMP protocol, to thereby search for image forming apparatuses supporting wireless communication within an infra network where the user device 300 is located. Also, the user device 300 may detect a USB port to thereby search for a USB printer connected to the USB port.

The user device 300 may receive and store information on image forming apparatuses from a plurality of image forming apparatuses retrieved by a search. In addition, the user device 300 may provide the user with information on the plurality of retrieved image forming apparatuses to thereby allow the user to select information on some image forming apparatuses to be stored in the user device 300.

Referring to FIG. 7, a user interface screen provided by the user device 300 according to an example is shown. The user interface screen of FIG. 7 may display the plurality of retrieved image forming apparatuses as a list. Further, information on the plurality of image forming apparatuses may be displayed together.

The information on the image forming apparatuses may include information such as a device name, a host name, an IP address, a location of the image forming apparatus, or the like. Further, the information on the image forming apparatuses may include information indicating the functions that may be supported by the image forming apparatuses and the statuses of the image forming apparatuses. For example, the information on the image forming apparatuses may include function information indicating whether a color printing function, an ECO function, a security function, a scan function, or the like may be used, and status information indicating whether the printer is malfunctioning, whether the job is overloaded, whether there are extra consumables, or the like. In addition, the information on the image forming apparatuses may also include information on the printable format of the print data.

The user device 300 may store information on all of the retrieved image forming apparatuses, or may store only information about some image forming apparatuses selected by the user.

In addition, the user device 300, according to an example, may provide the mobile terminal 200 with the information on the plurality of stored image forming apparatuses to thereby provide the user desiring to perform the image forming job through full printing with the list of image forming apparatuses by using the mobile terminal 200.

If receiving a request for the imaging forming job from the mobile terminal 200, the user device 300 may provide the information about the image forming apparatuses to the mobile terminal 200, and if receiving a request for the list of the image forming apparatuses from the mobile terminal 200, the user device 300 may provide information on the image forming apparatuses to the mobile terminal 200.

The mobile terminal 200 may receive information on the image forming apparatuses and provide the user with a list of available image forming apparatuses. The mobile terminal 200 may receive a user input of selecting one of the image forming apparatuses from the list of image forming apparatuses and transmit the user input to the user device 300 together with the request for the image forming job.

The user device 300 may determine an image forming apparatus to perform the image forming job based on the received user input. In addition, the user device 300 may store information on the selected image forming apparatus in association with the identification information of the mobile terminal 200. If receiving a request for the image forming job from the mobile terminal 200, the user device 300 may determine the image forming apparatus corresponding to the identification information of the mobile terminal 200 by using the already stored information.

The user device 300 may further receive and store setting information for the image forming job together with the user input of selecting the image forming apparatus from the mobile terminal 200. The user device 300 may provide information about the retrieved image forming apparatuses to the mobile terminal 200 and receive setting information on the image forming job selected by the user.

The user device 300 may request the determined image forming apparatus to perform the image forming job by transmitting the print data and the setting information to the image forming apparatus.

FIG. 8 is a diagram illustrating a process of performing an image forming job in a system that provides mobile printing, according to an example.

Referring to FIG. 8, when the user device 300 receives a print request from the mobile terminal 200, the user device 300 may not store information about the image forming apparatus corresponding to the identification information of the mobile terminal 200. For example, in FIG. 8, information on the image forming apparatus corresponding to the IP address 123.123.123.123 of the mobile terminal 200 is not stored in the memory of the user device 300.

If the user device 300, according to an example, does not store information on the image forming apparatus corresponding to the identification information of the mobile terminal 200, the user device 300 may determine that a default image forming apparatus performs the requested image forming job, or may request a push notification to ask the user's intention.

As an example, the user device 300 may request a push notification in order to execute an application for receiving a user input relating to the image forming apparatus in the mobile terminal 200. The user device 300 may transmit a push notification request to a push notification sever 400 that has authority to transmit the push notification to the mobile terminal 200.

When the request is received, the push notification server 400 may cause the execution of an application for receiving the user input on the image forming apparatus to be triggered by transmitting the push notification to the mobile terminal 200. For example, if the mobile terminal 200 receives the push notification, a message requesting a user input regarding the image forming apparatus may be displayed on a status bar or a pop-up window of a screen of the mobile terminal 200. If the user selects the displayed message, the mobile terminal 200 may execute an application for receiving user input regarding the image forming apparatus.

The mobile terminal 200 may receive the user's selection of the image forming apparatus to perform the image forming job and receive setting information necessary for the execution of the image forming job through the executed application. The mobile terminal 200 may transmit the received user input to the user device 300.

The user device 300 may determine the image forming apparatus by using information about the received image forming apparatus and store the information about the image forming apparatus in association with the identification information of the mobile terminal 200.

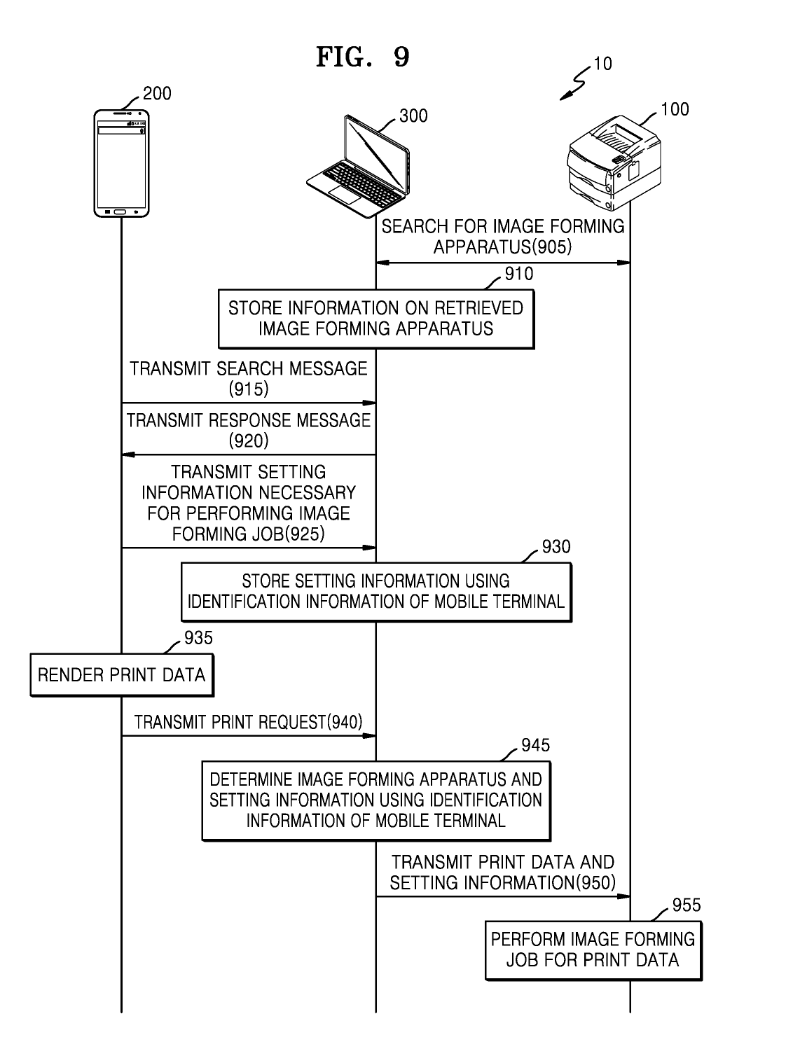

FIG. 9 is a diagram illustrating a process of a method of providing mobile printing in a system that provides mobile printing, according to an example.

Referring to FIG. 9, the system 10 for providing mobile printing according to an example may include the mobile terminal 200, the user device 300, and the image forming apparatus 100.

In operation 905, the user device 300 may search for the image forming apparatus 100.

The user device 300 may search for a plurality of image forming apparatuses connected to the user device 300 in a wired or wireless manner. For example, the user device 300 may search for image forming apparatuses that have already been installed with a driver through a printer driver installed in the user device 300. In addition, the user device 300 may transmit for a search message by using a network protocol such as an SNMP protocol to thereby search for image forming apparatuses supporting wireless communication within an infra network where the user device 300 is located. Also, the user device 300 may detect a USB port to thereby search for a USB printer connected to the USB port.

When the image forming apparatus 100 is retrieved, the user device 300 may store information on the image forming apparatus that is received from the retrieved image forming apparatus 100 in operation 910. The information on the image forming apparatus may include information such as a device name, a host name, identification information such as an IP address of the image forming apparatus, a location of the image forming apparatus, or the like. Further, the information on the image forming apparatus may include information indicating functions that may be supported by the image forming apparatus and a status of the image forming apparatus. For example, the information on the image forming apparatus may include function information indicating whether a color printing function, an ECO function, a security function, a scan function, or the like may be used, and status information indicating whether the image forming apparatus is malfunctioning, whether a job is overloaded, whether there are extra consumables, or the like.

Operations 905 and 910 may be performed in the order shown in FIG. 9, but may also be performed after operations 915 and 920 are performed.

In operation 915, the mobile terminal 200 may transmit a device search message based on the WS Discovery protocol to the user device 300.

When receiving the device search message from the mobile terminal 200, the user device 300 may transmit a response message based on the WS Discovery protocol to the mobile terminal 200 in operation 920.

The user device 300 may include information indicating a mobile printing function in a device category of the response message and transmit the information. The device category of the response message is a field indicating functions and roles that may be performed by the user device 300 transmitting the response message or services that may be provided by the user device 300.

In operation 925, the mobile terminal 200 may transmit the setting information necessary for performing the image forming job to the user device 300.

For example, the mobile terminal 200 may analyze the device category of the received response message to determine whether to use the user device 300 as a virtual image forming apparatus for the mobile printing. If the device category of the received response message includes information indicating the mobile printing function, the mobile terminal 200 may recognize the user device 300 as a virtual image forming apparatus and transmit setting information. The setting information includes information necessary for performing the image forming job. The setting information may include information on the printing paper at the time of a printing job, information about a number of copies, information about a printing method, information about a color setting, information on an ECO function setting, information on a security function setting, or the like and may be received from the user.

In addition, the mobile terminal 200 may receive the user's selection of the image forming apparatus to perform the image forming job and transmit the identification information of the selected image forming apparatus to the user device 300.

If the operation 935 is performed before the operation 925 is performed, the mobile terminal 200 may transmit the print request of operation 940 together with the setting information.

In operation 930, the user device 300 may store the received setting information using the identification information of the mobile terminal 200. For example, setting information corresponding to the identification information of the mobile terminal 200 may be stored.

In operation 935, the mobile terminal 200 may render the print data in a printable format. The mobile terminal 200 may render the print data through the operating system of the mobile terminal 200. The printable format is a data format which may be processed by image forming apparatuses including the image forming apparatus 100 and may include, for example, a PWG Raster, an OpenXPS, an MS XPS, a PCLm, or the like.

In operation 940, the mobile terminal 200 may transmit a print request to the user device 300 together with the print data.

In operation 945, the user device 300 may determine the image forming apparatus 100 to perform the image forming job and setting information necessary for the image forming job by using the identification information of the mobile terminal 200. The user device 300 may use the information on the image forming apparatus corresponding to the identification information of the mobile terminal 200.

Further, the user device 300 may convert the print data into a format printable in the determined image forming apparatus 100 and then transmit the print data.

In operation 950, the user device 300 may transmit the print data and the setting information to the determined image forming apparatus 100.

In operation 955, the image forming apparatus 100 may receive the print data and the setting information, and perform the image forming job for the print data.

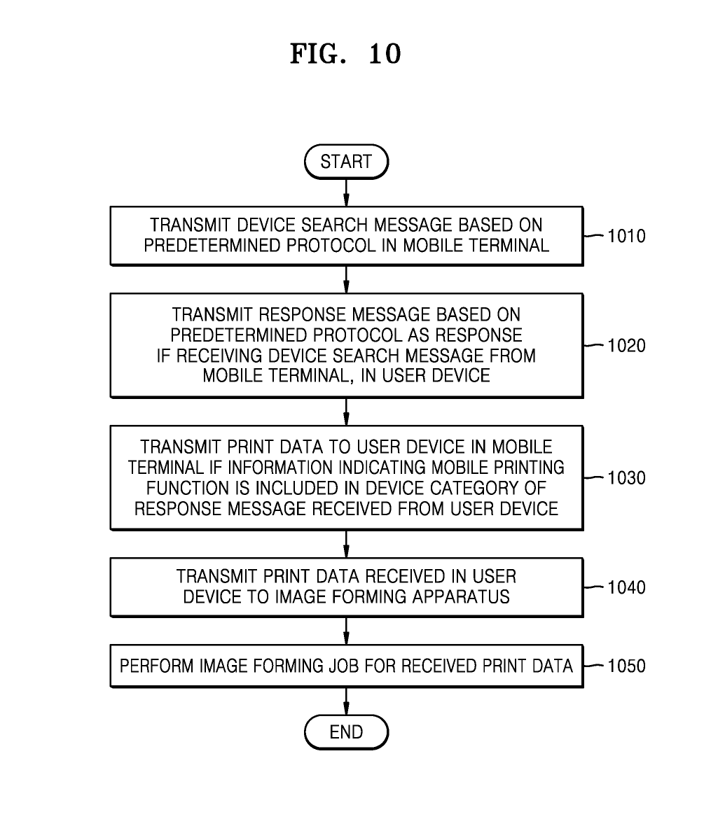

FIG. 10 is a flowchart illustrating a method of providing mobile printing, according to an example.

Referring to FIG. 10, the mobile terminal 200 may transmit a device search message based on a predetermined protocol in operation 1010. In operation 1020, the user device 300 supporting the predetermined protocol may receive the device search message received from the mobile terminal 200, and may transmit a response message based on the predetermined protocol to the mobile terminal 200 as a response.

In operation 1030, the mobile terminal 200 may analyze the response message received from the user device 300 and determine whether to perform mobile printing using the user device 300. For example, if information indicating the mobile printing function is included in the device category of the received response message, the mobile terminal 200 may decide to use the user device 300 and transmit the print data to the user device 300. At this time, the transmitted print data may be data rendered in a printable format through the operating system of the mobile terminal 200.

In operation 1040, the user device 300 may transmit the received print data to the image forming apparatus 100. For example, the user device 300 may store information on the image forming apparatus corresponding to the identification information of the mobile terminal 200. The information on the image forming apparatus may include identification information of the image forming apparatus and setting information necessary for performing the image forming job.

The user device 300 may determine the image forming apparatus 100 to perform the image forming job based on the identification information of the image forming apparatus corresponding to the identification information of the mobile terminal 200. The user device 300 may transmit the setting information corresponding to the identification information of the mobile terminal 200 to the image forming apparatus 100 together with the print data.

In operation 1050, the image forming apparatus 100 may perform the image forming job using the received print data and the setting information.

The above-described examples may be embodied in the form of a non-transitory computer-readable recording medium storing computer-executable commands and data. At least one of the commands and data may be stored in the form of program codes, and, when executed by a processor, a predetermined program module may be generated to perform a predetermined operation.

The non-transitory computer-readable recording medium may mean, for example, a magnetic storage medium such as a hard disk or the like, an optical reading medium such as a CD and a DVD, or the like, and may be a memory included in a server accessible via a network. For example, the computer readable recording medium may be at least one of the memory 140 of the image forming apparatus 100, the memory 240 of the mobile terminal 200, and the memory 330 of the user device 300.

While the present disclosure has been described with reference to the drawings and particular examples, those of ordinary skill in the art may make various changes and modifications therein without departing from the spirit and scope of the present disclosure. For example, the described techniques may be performed in a different order than the described method, and/or the described components such as systems, structures, devices, and circuits may be united or combined in a different form than the described method or may be replaced or substituted by other components or equivalents thereof.

What is claimed is:

1. A method of providing mobile printing, the method comprising:
transmitting a device search message based on a predetermined protocol in a mobile terminal;
transmitting, when a user device receives the device search message from the mobile terminal, a response message based on the predetermined protocol to the mobile terminal in response to the received device search message;
transmitting, when information indicating a mobile printing function is included in a device category of the response message received from the user device, print data from the mobile terminal to the user device;
transmitting the print data received from the user device to an image forming apparatus; and
performing an image forming job for the received print data in the image forming apparatus.

2. The method of claim 1, further comprising rendering the print data in a printable format through an operating system of the mobile terminal.

3. The method of claim 2, wherein the operating system of the mobile terminal is Windows 10 Mobile.

4. The method of claim 1, further comprising:
determining, by the user device, whether the print data received from the mobile terminal is of a format printable in the image forming apparatus; and
converting, by the user device, when the received print data is not of the format printable in the image forming apparatus, the received print data into the format printable in the image forming apparatus.

5. The method of claim 1, wherein the predetermined protocol is Web Services Dynamic Discovery (WS Discovery) protocol.

6. The method of claim 1, further comprising determining, by the user device, the image forming apparatus to perform the image forming job for the print data by using identification information of the mobile terminal having transmitted the print data.

7. The method of claim 1, further comprising, when setting information necessary for performing the image forming job corresponding to identification information of the mobile terminal having transmitted the print data does not exist in the user device, transmitting, by the user device, a signal for requesting the setting information.

8. A non-transitory computer-readable recording medium having recorded thereon instructions for executing, in a computer, a method of providing mobile printing, the non-transitory computer-readable recording medium comprising:
instructions to transmit a device search message based on a predetermined protocol in a mobile terminal;
instructions to transmit, when a user device receives the device search message from the mobile terminal, a response message based on the predetermined protocol to the mobile terminal in response to the received device search message;
instructions to transmit, when information indicating a mobile printing function is included in a device category of the response message received from the user device, print data from the mobile terminal to the user device;
instructions to transmit the print data received from the user device to an image forming apparatus; and
instructions to perform an image forming job for the received print data in the image forming apparatus.

9. The non-transitory computer-readable recording medium of claim 8, further comprising instructions to render the print data in a printable format through an operating system of the mobile terminal.

10. The non-transitory computer-readable recording medium of claim 9, wherein the operating system of the mobile terminal is Windows 10 Mobile.

11. The non-transitory computer-readable recording medium of claim 8, further comprising instructions to:
determine, by the user device, whether the print data received from the mobile terminal is of a format printable in the image forming apparatus; and
convert, by the user device, when the received print data is not of the format printable in the image forming apparatus, the received print data into the format printable in the image forming apparatus.

12. The non-transitory computer-readable recording medium of claim 8, wherein the predetermined protocol is Web Services Dynamic Discovery (WS Discovery) protocol.

13. The non-transitory computer-readable recording medium of claim 8, determining, by the user device, the image forming apparatus to perform the image forming job for the print data by using identification information of the mobile terminal having transmitted the print data.

14. The non-transitory computer-readable recording medium of claim 8, further comprising instructions to transmit, by the user device, when setting information necessary for performing the image forming job corresponding to identification information of the mobile terminal having transmitted the print data does not exist in the user device, a signal for requesting the setting information.

15. The non-transitory computer-readable recording medium of claim 8, further comprising instructions to:
receive, by the user device, setting information necessary for performing the image forming job from the mobile terminal; and
match the received setting information with identification information of the mobile terminal and storing the matched setting information.
